(19) United States
(12) Patent Application Publication
(10) Pub. No.: US 2016/0335534 A1
(43) Pub. Date: Nov. 17, 2016

(54) NEURAL SENSOR HUB SYSTEM

(71) Applicant: Thalchemy Corporation, Madison, WI (US)

(72) Inventors: Andrew Nere, Madison, WI (US); Atif Hashmi, Fremont, CA (US); Michael Eyal, Madison, WI (US); Mikko H. Lipasti, Lake Mills, WI (US); John F. Wakerly, Glenview, IL (US)

(21) Appl. No.: 15/154,394

(22) Filed: May 13, 2016

Related U.S. Application Data
(60) Provisional application No. 62/161,717, filed on May 14, 2015.

(51) Int. Cl. G06N 3/04; G06N 3/08

(52) U.S. Cl. CPC G06N 3/0445; G06N 3/08

(57) ABSTRACT

Systems and methods for a sensor hub system that accurately and efficiently performs sensory analysis across a broad range of users and sensors and is capable of recognizing a broad set of sensor-based events of interest using flexible and modifiable neural networks are disclosed. The disclosed solution consumes orders of magnitude less power than typical application processors. In one embodiment, a scalable sensor hub system for detecting sensory events of interest comprises a neural network and one or more sensors. The neural network comprises one or more dedicated low-power processors and memory storing one or more neural network programs for execution by the one or more processors. The output of the one or more sensors is converted into a spike signal, and the neural network takes the spike signal as input and determines whether a sensory event of interest has occurred.

### CROSS-REFERENCE TO RELATED APPLICATION

This application claims the benefit of U.S. Provisional Patent Application No. 62/161,717, Filed May 14, 2015, which is hereby incorporated by reference in its entirety.

### FIELD OF THE INVENTION

The present invention relates generally to sensor hub systems, and in particular to methods and apparatuses for a more adaptable and scalable sensor hub system using neural networks.

### BACKGROUND OF THE INVENTION

Smart devices, wearables, and other gadgets in the Internet of Things (IoT) include a broad number of sensors, including accelerometers, gyroscopes, microphones, proximity sensors, ambient light sensor, pressure sensors, heart rate monitors, biometric sensors, and many more. Such devices have the potential to use the data generated by these sensors to enable gesture and voice based control, provide indoor navigation, monitor user activity and safety, provide a high degree of environmental awareness, and interpretation of a user's context, behavior, and posture. The vast majority of these devices perform all sensor data analysis and interpretation on a primary application processor. However, a recent trend for some of these devices is to utilize a dedicated low-power microprocessor to offload a large amount of sensory processing from the application processor, such as the system described in an article “Littlerock: Enabling energy-efficient continuous sensing on mobile phones” by Priyantha, Bodhi, Dimitrios Lymberopoulos and Jie Liu. Pervasive Computing, IEEE 10.2 (2011) and U.S. Pat. No. 8,706,172 “Energy efficient continuous sensing for communications devices” issued to Priyantha, Nissanka Arachchige Bodhi, Jie Liu, and Dimitrios Lymperopoulos. These low-power microcontrollers interfaced with sensors are typically referred to as Sensor Hubs, and they perform the first tier of sensory processing in systems which include them. These systems may utilize a single sensor hub processor interfacing multiple sensors, or multiple sensor hub processors connected to one or more sensors. It should be noted that for smart devices such as a smartphone, the design approach may be to include both a powerful application processor and a more power efficient sensor hub processor. For other devices, such as IoT devices and wearable devices, where space and battery life are even more limited, the sensor hub processor may be the only processing hardware on the device.

For smartphones, wearables, and other IoT devices, maximizing the battery life of the device is of the utmost importance. However, each subsequent generation of these devices includes more and more sensors which can be leveraged for new and exciting applications, such as “always on” voice recognition, gesture control, exercise monitoring, activity classification, biometric authentication, and environmental and context aware applications. Processing streaming sensory data on these devices often presents a significant challenge for several reasons.

First, the sensors themselves are capable of generating a large amount of data, especially when they are kept “always on” and/or utilizing a high sampling rate. Processing and analyzing this data on the main application processor consumes an unnecessarily large amount of battery power, especially when one considers that much of the sensory data is uninteresting, and the “events of interest”, such as a spoken command or a gesture, are rare. One of the clear needs is to perform sensory analysis in a way that does not significantly impact device battery life. This means the microprocessor on which the software is deployed must consume low power, and the software itself must be extremely efficient and lightweight and must minimize resource utilization to the highest degree possible.

Second, accurately detecting the sensory “events of interest” also presents a significant challenge for these devices. Detecting command words, gestures, activity and exercise, and other “events of interest” is quite difficult, especially when considering a broad population of users with different physical builds, accents, and other characteristics. When combined with the fact that the sensory analysis algorithms must be lightweight and computationally efficient, this challenge is only made more difficult. Therefore, there is also a clear need for a system that can accurately perform sensory analysis across a broad range of users and sensors.

Third, the method in which the streaming sensory data is processed must be flexible and adaptable for new applications, recognition capabilities, new sensors, and variable sensor sampling rates. These devices need to be able to take advantage of newer, more accurate algorithms, or utilize more sensors to reduce false positive recognitions. Although dedicated and energy efficient custom hardware has been proposed for sensory analysis, such as those described in U.S. patent application Ser. No. 13/749,854 “Sensory Stream Analysis Via Configurable Trigger Signature Detection” by Mikko Lipasti, Atif Hashmi, Andrew Nere and Giulio Tononi, there are clear advantages to a system composed of a microprocessor paired with a flexible and modifiable software solution.

In current systems, each time a new capability is required, or a new sensor is added to the system, then new sensory processing algorithms must be created, invented, and/or coded. For example, the algorithms or software written to analyze accelerometer data to count a user's steps is quite different than the algorithms or software written to analyze microphone data to detect a user's command word (or hot-word) which in turn is quite different that the algorithms or software for detecting the activity of driving a car or riding a bicycle.

Even when considering a single sensory modality, such as the accelerometer, the typical solution is to invent and utilize different algorithms are used for different tasks. For example, an algorithm capable of detecting user steps from accelerometer data, as well as its software implementation, will be entirely different from the algorithm/software used to detect a motion-based gesture, such as drawing a circle in the air. Even across different motion-based gestures, all using accelerometer data, different algorithms and software approaches may be used. For example, the circle gesture described above may last for 1-2 seconds, and can be implemented with an algorithm that samples the accelerometer at a fairly slow rate (e.g. 10 Hz). However, another gesture, “double tapping” the side of the device, is very quick—much less than 1 second in duration. The accelerometer signatures of the “taps” are so brief that they require a much faster sampling rate (e.g. 100 Hz or more).

So far, the use of different algorithms and software for different tasks has been the typical approach to the sensory processing problem; for each new task or sensor, a new “widget” must be invented, and a new block of source code must be written to enable it. While this approach has worked for a minimal set of use cases and user applications, it is clear that this type of model is not scalable. For each new sensor, or each new interesting sensor event that one wishes to detect, a new algorithm must be constructed and new software written. Not only is this a burden on the software developer, but it also becomes infeasible on the limited-resource sensor hub systems that are deployed in such devices. Thus, there is a clear need for a system that can be generally applicable across a broad set of sensors and is capable of recognizing an even broader set of sensor-based events of interest.

### SUMMARY OF THE INVENTION

Modern smart devices such as smartphones, tablets, Internet of Things (IoT) devices, and smartwatches contain an ever-growing number of sensors, which can be leveraged for improved user interfaces and device control, human activity and exercise monitoring, and environmental and context-aware applications. While many of these sensors themselves are considered low power, the typical application processors interfaced to these sensors are quite power hungry. To enable a more continuous, or “always on”, sensory processing capability, many device manufacturers have opted to include a dedicated coprocessor, or a sensor hub processor, in their designs.

The primary advantage of these sensor hub systems is that they use orders of magnitude less power than typical application processors, such as the system described in article “Littlerock: Enabling energy-efficient continuous sensing on mobile phones” by Bodhi Priyantha, Dimitrios Lymberopoulos and Jie Liu or the ones described in U.S. Pat. No. 8,706,172 “Energy efficient continuous sensing for communications devices” issued to Nissanka Arachchige Bodhi Priyantha, Jie Liu and Dimitrios Lymperopoulos. However, to achieve this benefit, there obviously are tradeoffs with the sensor hub coprocessor design: primarily that these designs are significantly limited in terms of their compute capability, as well as other resources such as memory and specialized functional units, such as floating-point Arithmetic Logic Units (ALUs). Typical sensor hub systems include between 8 KB and 128 KB of RAM, and between 32 KB and 512 KB of flash memory, with peak operating frequencies of 100 MHz or less. Such performance and resources are clearly limited when compared to those of a typical application processor, which operates at frequencies above 1 GHz and utilizes several gigabytes of memory. This trend will likely continue for the foreseeable future; sensor hub microprocessors will have at least one order of magnitude less CPU power, and several orders of magnitude less memory, than their application processor counterparts.

The limited resources and compute power of these sensor hub systems, paired with power constraints of the system, clearly indicate the need for a computationally lightweight and resource-efficient software component. Providing such a software component is a significant challenge considering that the goal of such sensor hub systems is to interface to all types of sensors, including gyroscopes, pressure sensors, accelerometers, microphones, proximity sensors and more, and the desired concurrent applications are “always on” voice recognition, gesture recognition, human activity and exercise monitoring, and many more.

### BRIEF DESCRIPTION OF THE DRAWINGS

These and other aspects and features of the present invention will become apparent to those ordinarily skilled in the art upon review of the following description of specific embodiments of the invention in conjunction with the accompanying figures, wherein:

FIG. 1 illustrates a basic Neural Sensor Hub System according to one aspect of the present invention.

FIG. 2 illustrates a typical network architecture of an LSM that can be used in a neural sensor hub system according to the present invention.

FIG. 3 illustrates a signed linear thermometer encoder used in a neural sensor hub system according to the present invention.

FIG. 4 illustrates an embodiment of a neural sensor hub system with multiple neural networks instantiations according to another aspect of the present invention.

FIG. 5 illustrates an embodiment of a neural sensor hub system capable of pre-condition and post-condition checking according to another aspect of the present invention.

### DETAILED DESCRIPTION OF THE PREFERRED EMBODIMENTS

The following sections provide a detailed description relating to an embodiment of the Neural Sensor Hub System (NSHS)

As discussed above, there is a clear need for a system that satisfies the following requirements: (1) It is low power, (2) It can easily interface to multiple sensor types, (3) It can accurately detect sensory events of interest and (4) It provides a high degree of flexibility for enhancing event detections or adding new ones.

Low-power microcontroller hardware, colloquially known as a Sensor Hub, has previously been introduced as a hardware solution for requirements (1) and (2). See, e.g., the article “Littlerock: Enabling energy-efficient continuous sensing on mobile phones” by Bodhi Priyantha, Dimitrios Lymberopoulos and Jie Liu or the U.S. Pat. No. 8,706,172 “Energy efficient continuous sensing for communications devices” issued to Nissanka Arachchige Bodhi Priyantha, Jie Liu and Dimitrios Lymperopoulos. However, the burden of all four requirements falls on the software running on the sensor hub system, and they have thus far gone unmet. Software must be computationally efficient to minimize processing time, which directly impacts the amount of current draw from a battery (and thus, directly impacts battery life). The software must be flexible enough to process sensory data from very different sensors; otherwise, individual algorithms and software stacks require not only more processing time, but also more memory in resource limited sensor hub systems. And finally, the software not only needs to provide highly accurate sensory processing capabilities, it should also be flexible enough to accommodate the inclusion of new or changing features and capabilities.

In this embodiment described below, a system consisting of software-based neural-network algorithms deployed on sensor hub hardware fulfills the four requirements outlined above. The neural-network algorithms used in this embodiment can be trained to accurately detect sensory events of interest across all types of sensors, including, but not limited to, accelerometers, gyroscopes, microphones, magnetometers, proximity sensors, ambient light sensors, and pressure sensors. For example, the NSHS can be configured to detect a motion-based gesture using the gyroscope, a spoken command word using the microphone, or human activity/exercise using the accelerometer. The NSHS may be trained with the system and/or methods as described in U.S. patent application Ser. No. 14/640,424 “Learn-by-example Systems and Methods” by Andrew Nere et al, which is incorporated herein by reference. The NSHS may be trained on both true-positive examples (that is, the events-of-interest that should be recognized, such as a spoken command word) and false-positive examples (that is, the other events which should not trigger a recognition, such as the noise and conversations in a busy coffee shop).

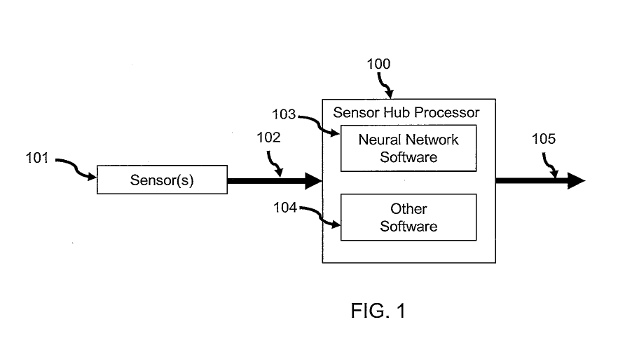

FIG. 1. illustrates a basic Neural Sensor Hub System (NSHS) according to one aspect of the present invention. The NSHS includes one or more sensors 101 and a neural processing unit. The Neural Processing Unit includes a Sensor Hub Processor (100) and memory (not shown). Sensor Hub Processor 100 is used as the execution substrate for the NSHS. Sensor Hub Processor 100 is connected to Sensor 101 which communicates sensory data to Sensor Hub Processor 100. The communication (102) may either be through wired or wireless connections, such as, but not limited to, I2C, I2S, Bluetooth, and Wi-Fi. In some embodiments, one or more of the sensors (101) may be integrated or combined in the same chip or package with Sensor Hub Processor 100. A neural network software (103) executes on Sensor Hub Processor 100, which analyzes incoming sensory data in real-time. Other software (104) may also execute on Sensor Hub Processor 100, such as, but not limited to, a Real-Time Operating System (RTOS), power management software, and other sensory analysis algorithms.

In a preferred embodiment, the neural network software is based on the Liquid State Machine (LSM) neural-network algorithm. A LSM is a modern neural algorithm, significantly different from the traditional Multi-Layer Perceptron neural network. LSMs are often used as a computational construct for the task of classifying time-varying signals. See, e.g., patent application Ser. No. 13/749,854, “Sensory Stream Analysis Via Configurable Trigger Signature Detection” by Mikko Lipasti, Atif Hashmi, Andrew Nere and Giulio Tononi.

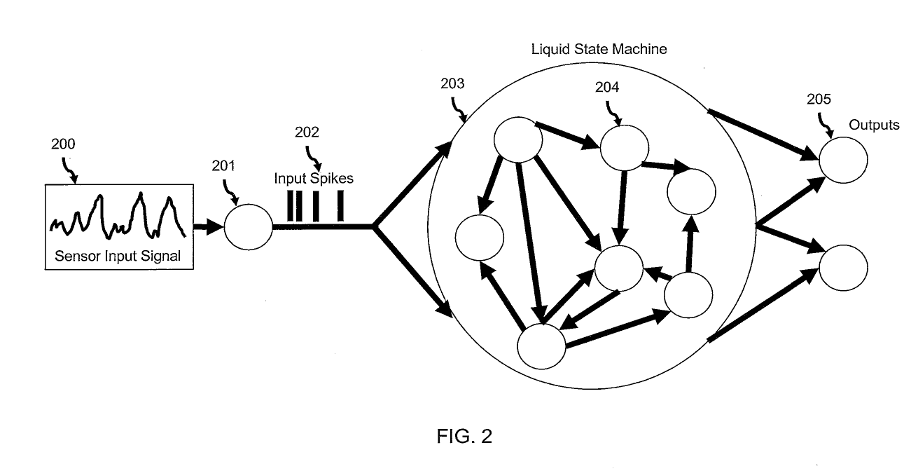

FIG. 2 illustrates a typical network architecture of an LSM that can be used in a NSHS according to the present invention. LSMs are typically composed of a number of modeled neurons, which are randomly and recurrently connected to each other—and in most applications, these connections are not changed after they are created. Recurrently-connected neural networks (such as LSMs) are a class of neural network in which cyclic connections can exist, as shown in FIG. 2. This is different than traditional neural networks, in which information flows only in one direction (i.e. a feed-forward Multi-Layered Perceptron, where information flows from “bottom” to “top”). In FIG. 2, a subset of the neurons in the LSM receives a time-varying input from an external source. In typical operation, a time-varying signal, such as an audio signal (200), is the input to the network. With an LSM, typically some type of encoder (201) is used to convert the raw signal into a spike signal (or spikes) (202), which serve as the inputs to the LSM (203). The LSM itself is typically composed of spiking integrate-and-fire neurons (204) or a similar spiking neuron model. In the majority of LSM implementations, the connectivity between the neurons in an LSM is random but unchanging. Finally, the activity states of the LSM are typically classified by one or more different output units (205), which may be linear threshold units, perceptrons, multi-layered perceptrons, deep networks, or another type of classifier.

The LSM turns the time-varying input into a spatiotemporal pattern which captures both the current and past inputs to the LSM. The process is somewhat analogous to the way that a Fast Fourier Transform converts a signal represented in the time domain to the frequency domain. In most applications of LSM neural networks, there is no training/learning in the LSM itself. Typically, in LSMs, linear output units, or readout units (205) as shown in FIG. 2 can be trained to classify the unique spatiotemporal patterns generated by the LSM. Often, the architecture of the LSM is “initialized” but not trained; however it is noted that in this disclosure the architecture of the LSM may also be trained or adapted to aid in accurate recognition and classification of patterns of interest. Variations of the LSM architecture parameters, such as the network size, the number and types of connections, connection strength, will determine the spatiotemporal patterns the network can create. A well-designed LSM neural network is capable of creating linearly separable spatiotemporal patterns (with or without online training/learning) that can be easily classified by simple linear output units. However, it should be noted that the disclosed invention is not limited to LSMs that create linearly separable spatiotemporal patterns, but is also applicable to LSMs that don't create linearly separable patterns. Furthermore, a well-designed LSM is capable of tolerating distorted or noisy variations of inputs, making it a robust computational construct for analyzing streaming sensory data.

One key consideration for the NSHS is that streaming sensory input, such as data from an accelerometer or a microphone, must be converted from an audio or digital representation of the data, into a spike signal, or “spikes”, which can be processed by the LSM. In FIG. 2, module 201 performs this “spike encoding” process, translating the incoming data into the “spike” representation. In the design of a robust LSM system capable of recognizing sensory events of interest, the implementation of this encoder is a key component.

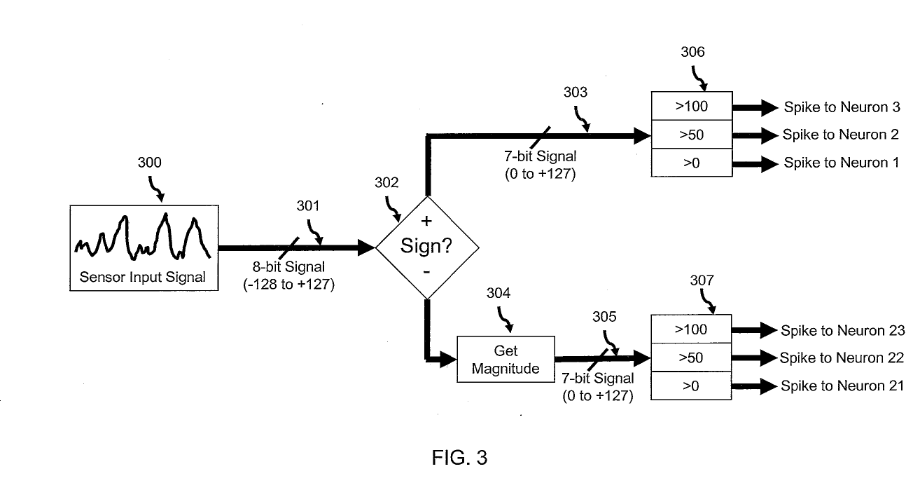

FIG. 3 illustrates a signed linear thermometer encoder used in a NSHS according to the present invention. For this example, it is assumed that the input to the NSHS is a single-axis 8-bit digital accelerometer (300) operating at a sampling rate of 20 Hz. Every 50 ms, a signed 8-bit value (301) is produced by the accelerometer. The sign of the incoming value is determined (302) to decide if the data will create spikes in the positive encoder bank or the negative encoder bank. Positive-sign values are 7-bit values between 0 and 127 (303) as the sign of the signal is no longer needed. For negative-sign values, the sign bit is discarded and the magnitude is determined (304) and is also represented with a 7-bit value (305). If the incoming accelerometer value was positive (303), then the positive thermometer encoding bank (306) is used. In this simple example, the bank contains 3 comparators, which check if the incoming positive accelerometer value has crossed a threshold. If the threshold is crossed, a spike is propagated in this cycle from the encoder to a targeted spiking neuron in the LSM. The same scheme is applied to negative accelerometer values with their own encoder bank (307) and their own target neurons. While the figure discloses and describes the operation of a signed linear thermometer encoder, it should be noted that alternative spike encoding schemes may be used. For example, a non-linear encoding scheme following an exponential function may be used. Other alternatives may include, but are not limited to, pass band encoders, a simple threshold scheme, or an encoder following a Poisson distribution. It should also be noted that prior to encoding sensor data into spikes, other pre-processing may be utilized to modify the incoming data. For example, accelerometer data may pass through a low-pass filter to remove high frequency noise before encoding. Other types of data pre-processing may include, but is not limited to, taking the Fast-Fourier Transform (FFT) of the incoming data, calculating standard deviation, mean, minimum and maximum values over a window of data, other filtering schemes, scaling, or calculating the integrals or derivatives of the incoming data. Any of these filtering, scaling, or manipulation techniques may occur before the data is encoded as spikes to be processed by the LSM neural network.

To give an example of the simple encoder described in FIG. 3, consider an incoming accelerometer value of 55. Since the value is positive, the positive branch (303) is chosen. 55 is greater than 0 and 50, so one spike is sent to LSM neuron 1, and another is sent to LSM neuron 2. At the next 50 ms input, the incoming value is −111. The negative branch (304) is chosen, and +111 is greater than the threshold of all 3 comparators in the bank. Therefore, this incoming value results in three spikes, which target LSM neurons 21, 22, and 23.

We note that this simple spike-encoder scheme is just one possible implementation, and it serves to illustrate how a digital sensor's data can be sampled and encoded into the “spike” language used by spiking neural network models such as the LSM described above. Alternative encoding schemes may vary in complexity, include various stages of filtering of the incoming sensor signal, and target more than one neuron in the LSM (as opposed to the single-target implementation shown in FIG. 3). That is, an output spike from the encoder resulting from crossing one particular threshold can be sent to more than one LSM neuron. While not shown in FIG. 3, the described embodiment utilizes this “spike fan-out” scheme. The particular targeted LSM neurons may be static, or may be changed during operation.

The NSHS discussed above is distinct from other conventional sensor hub systems in the sense that it uses a spiking LSM neural network for the task of analyzing sensory input. In previously published literature, LSMs have been shown to be quite good at pattern recognition, including audio inputs, see, e.g., the Master's Thesis entitled “On real-world temporal pattern recognition using Liquid State Machines” by Jilles Vreeken, University Utrecht (NL), 2004. However, little to no work has explored the use of these LSM neural networks in real time, deployed on a sensor hub system.

Besides the novelty of using an LSM for sensory processing in real time, the NSHS is also unique in the choice to use simple spiking Linear Integrate-and-Fire (LIF or I&F) neurons. LIF neurons are considered to be the most computationally simple spiking neuron model. This means that they do not model many attributes of true biological neurons. More complex neuron models, like the Hodgkin Huxley neuron, Izhikevich neuron, or Morris-Lecar neuron, are developed to specifically target a higher biological fidelity than the simple LIF neurons. See, e.g., “Which model to use for cortical spiking neurons?” by Izhikevich, Eugene M., IEEE transactions on neural networks 15.5 (2004): 1063-1070. According to the author, these more biologically accurate neuron models are a necessity, and it has been claimed, “despite its simplicity, I&F is one of the worst models to use in simulations.” In a conference paper by Beata J. Grzyb et al, which has specifically investigated neuron models for LSM neural networks, it is concluded that “taking into account both the entropy and separation ability . . . Morris-Lecar, resonate-and-fire, and Hindmarsh-Rose '85 (for lower density of connections) neurons are the most suitable for LSM implementation.” See, Grzyb, Beata J., et al. “Which model to use for the liquid state machine?” Neural Networks, 2009, IJCNN 2009, International Joint Conference on IEEE, 2009.

This prior art clearly teaches away from the use of LIF neurons for LSM based applications. Furthermore, considering the strict memory and compute limitations of sensor hub microprocessors (as Sensor Hub Processor 100 described above), it is understandable why spiking neural networks (such as LSMs) have not been deployed on sensor hub hardware. Given information of this prior art, one would assume that the computational complexity and memory requirements for an LSM are simply too high for a sensor hub system.

However, in implementing the NSHS, the simplified LIF neuron model was specifically targeted due to these constraints. The NSHS has been shown to be capable of processing audio information for always-on command word recognition, as well as always-on gesture recognition and human activity monitoring when interfaced with inertial sensors, such as the accelerometer and gyroscope. “Always-on” means that an embodiment of the NSHS has sufficiently low power that it can analyze inputs continuously while consuming a low amount of battery power, without requiring other means to selectively disable analysis to conserve battery power. This capability is, in part, due to the fact that the NSHS leverages a unique scheme for efficiently re-computing the neural network connectivity, which is described in Patent Application 62/058,565 and incorporated herein by reference. Paired with the simple spiking LIF neuron models, the NSHS is able to perform a variety of real-time sensory processing tasks, while fitting in the resource-constrained a sensor hub microprocessor.

More importantly, the NSHS described above has various advantages of the NSHS for the task of sensory data processing. One of the primary advantages of using a dedicated low-power sensor hub microprocessor, as opposed to a dedicated ASIC or hardware design, is that it provides a high degree of software flexibility. In the described embodiment, the NSHS takes clear advantage of this flexibility.

One of the ways the NSHS takes advantage of the flexibility of software is through multiple instantiations of the neural network software, which can concurrently or independently execute on a neural processing unit. Each of the neural networks may process data from the same sensors, different sensors, or various combinations of the sensors. Sensors may be sampled at the same rate or different rates within or across different neural network instantiations.

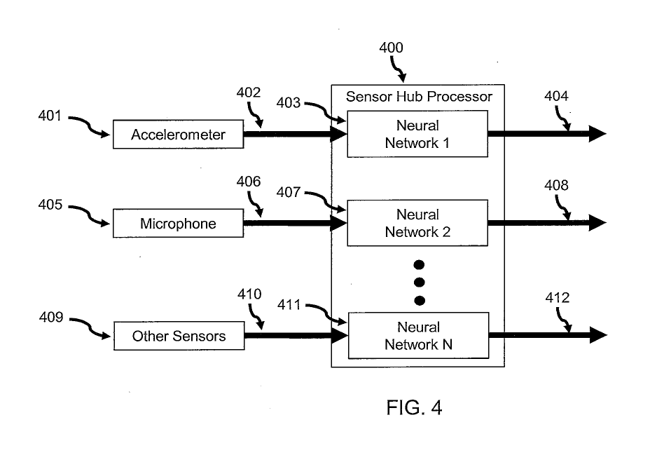

FIG. 4 illustrates an embodiment of a neural sensor hub system with multiple neural networks instantiations according to one aspect of the present invention. As before, the software is executed on a sensor hub microprocessor (400). In this embodiment, an accelerometer sensor (401) propagates sensory data via an I2C bus (402) to one neural network instantiation (403), which performs gesture recognition on the accelerometer. Outputs (404) may then be communicated to a user, an application processor, a data log, or some other device or component. The outputs (404) may be a classification (e.g. Gesture A just happened, or Gesture B just happened), a confidence level (e.g. Gesture A happened with 70% certainty), or multiple simultaneous classifications and/or confidence levels (e.g. Gesture A happened with 70% confidence and Gesture B happened with 90% confidence).

In the described embodiment, other sensor data is processed by other neural network instantiations concurrently. In the described embodiment, a microphone sensor (405) propagates sensory data via an I2S bus (406) to another neural network instantiation (407), which performs “hot word” recognition, and similarly, communicates its outputs (408) to a user, application processor, data log, or some other device or component. Similarly, for any other sensor or set of sensors (409), data is propagated (410) to a neural network instantiation (411) to perform some sensory processing task, which then communicates its output (412).

It should be noted that FIG. 4 serves as a single example embodiment of the NSHS using multiple instantiations, and should not limit the scope of this feature. Neural network instantiations may use the same sensors for different tasks. For example, two instantiations may both utilize accelerometer and gyroscope sensor data, but Neural Network 1 may perform data analysis for gesture recognition, while Neural Network 2 may perform data analysis for human activity and exercise monitoring, such as detection of walking, running, jogging, cycling, riding the bus, driving a car, or many other activities. Even within a single application domain, such as exercise and monitoring, a different neural network may be trained, configured, and used for different sub-categories. Examples may include, but are not limited to detecting different types of swings for racket sports (forehand, backhand, serve, etc.), detecting different types of punches for a boxing routine (cross, jab, uppercut, etc.), detecting different poses in a yoga workout, or detecting different types of strokes in a swimming workout.

Different Neural Networks may use different sampling rates of the same sensor. For Example, Neural Network 1 may sample accelerometer data at 100 Hz to detect taps or double taps for example, while Neural Network 2 may sample data at 10 Hz to detect slow gestures like lifting the phone to the ear.

Because the neural network algorithms of the NSHS are implemented in software, the NSHS can also leverage many computational and resource management optimizations. Such optimizations translate directly into power savings, as well as improved response times. These optimizations also have indirect advantages; as software becomes more efficient, the features and capabilities of the NSHS can be expanded. For example, consider an embodiment of the NSHS with a single neural network performing gesture recognition, in which the single neural network utilizes 100% of a sensor hub microprocessor's CPU performance. When an algorithmic optimization happens that reduces the required CPU utilization to 50%, one may either reduce the CPU frequency (decreasing power utilization), or add another neural network instantiation for a new task (e.g. a neural network for detecting “hot words”).

One of the key advantages of the NSHS is the fact that the underlying algorithm, which is performing the sensory data analysis and event-of-interest recognition, is highly flexible and adaptable. As one familiar in the art of neural networks can appreciate, neural networks can be trained for a broad variety of tasks, while the underlying concepts, algorithms, and code remain the same. That is, the same neural network algorithm can be used to analyze accelerometer data for detecting motion-based gestures as well as audio data for detecting spoken “hot words”. The most straightforward approach would be that these two tasks are handled by two separate instantiations of the same neural network algorithm, and each instantiation then has its own independent set of neural network parameters, such as trained weights, thresholds, etc. However, it is not a requirement that these different tasks, with their different sensory data, be performed on two separate instantiations; however, as one skilled in the art of neural network methodologies can appreciate, it is the most straightforward approach.

In the case where two (or more) instantiations are performing two (or more) tasks, one clear advantage of the NSHS system is code re-usability. In the example provided, an audio analysis and an accelerometer analysis application both utilize the same neural network, which, in the NSHS, can be the same underlying source code. While the data structures for the two instantiations are separate, the source code is the same. This provides a significant advantage over traditional approaches, which, for this task would likely require independent source codes and data structures for audio analysis and accelerometer analysis. As the number of sensor and the number of tasks increases, it is clear that traditional approaches are not scalable, especially when considering the limited resources of sensor hub microprocessors. Each new task requires a new “widget” which includes both source code and data structures. Hence, the clear advantage of the NSHS is that a single algorithm, and single source code, can be used for a broad variety of applications and tasks.

Alternatively, rather than using a single source code with an individual data structure for each neural network instantiation, the neural networks in the NSHS can be “compiled” directly. That is, rather than having multiple data structures, such as an array, which is populated to describe the connectivity of the neural network, the connections, weights, and other parameters, are simply part of the source code. That is, the structure of Neural Network A is directly included in its source code, while the same is true for Neural Network B. The key here is the “compiled” version means larger code blocks, but less RAM utilization, while the previous approach means smaller code blocks but greater RAM utilization. At the same time, the “compiled” version may execute faster than the non-compiled approach because it need not access and interpret data structures to obtain neural network connections, weights, and other parameters. Depending on the platform and other constraints, one approach for the NSHS may be more appropriate than the other. Furthermore, in the NSHS, hybrid schemes, which favor “code reusability” in some segments, but are “individually compiled” in other segments, can be used.

Furthermore, the fact that the NSHS utilizes a software implementation of the neural network algorithms allows for many opportunities for algorithmic optimization. A software implementation of the neural network allows for the consideration of the 80/20 rule; that is, one may focus on optimizing the 20% of the code where 80% of the execution time is spent.

In one embodiment of the NSHS, the “20%” of the code where “80%” of the execution time is spent may be the communication between neurons in the LSM. That is, the majority of the time and complexity of the algorithm surrounds the connectivity and communication between the LSM neurons during normal operation. In such an embodiment of the NSHS, this segment of the code can be optimized utilizing the methodology/system described in Patent Application 62/058,565. Alternatively, such segments of the code could be optimized with traditional techniques, such as implementing segments in assembly language for peak efficiency, or other techniques known to one skilled in the art of software optimization.

Another advantage of the NSHS is that platform-specific optimizations can be performed. For example, Sensor Hub Processor A may have ½ the maximum CPU frequency and 2× the available memory of Sensor Hub Processor B. In this case, the neural network running on Sensor Hub Processor A may utilize look-up-tables, stored in memory, for different functions of the modeled neurons, since memory is a more bountiful resource. Sensor Hub Processor B, which has a higher CPU frequency, but smaller memory resources, may instead actually implement the functions of the modeled neurons in software.

Another memory optimization, which Sensor Hub Processor B can use when memory resources are sparse, is efficient “packing” of neural network and the readout/output weights of the corresponding neural network. The readout/output units may be a linear output unit, a perceptron, a multi-layered perceptron, or one of many other classification algorithms used to categorize the current state of the LSM. Typically the readout/output units have weights associated with each element of the LSM, though sparse connectivity schemes may also be used here. If, for example, each signed weight has a resolution that is represented by 5 bits, but the typical smallest representation for most modern processors is 1 byte (8 bits), then 3 bits per weight is lost. However, an efficient bit packaging scheme would allow us to utilize these “lost” bits, by packing the weights' sign-bits separately from their 4 mantissa bits. In that case, some bytes in the memory pool would be designated as mantissa carriers, containing the 4 mantissa bits of two readout weights, and some bytes would be designated as sign-bit carriers, containing sign-bits for 8 readout weights. With low-cost masking and shift operations the compressed weights can be easily “unpacked” and the original 5-bit weight restored, when needed. This scheme can reduce the required memory block dedicated for the readout weights by approximately 37%. A second approach for compressing the memory area of the readout weights is to ignore weights that have a zero value. It is often the case where a readout has elements associated with zero weights, and in some of those cases, instead of packing all weights, it would be wiser to store only the non-zero weights, and add a dictionary that tells the NSHS which elements have zero readout weights and can be ignored.

Some sensor hub microprocessors may have special hardware components, such as a floating-point ALU, while others have only fixed-point functional units. Because the NSHS implements its neural network algorithms in software, the NSHS can be customized according to which resources are available or not on each targeted hardware platform.

Furthermore, as workloads change, a software implementation of the neural networks in the NSHS allows for changes in the optimizations. For example, consider a NSHS that is originally targeted to recognize five gestures using the accelerometer sensor only. Then, it is decided that the NSHS must now support the recognition of ten unique gestures using both the accelerometer and gyroscope. As the “workload” of the NSHS has changed, so might the optimization.

Because the NSHS employs software running on a microprocessor, additional functions and capabilities, whether neural-network-based or otherwise, can easily be added. For example, the detection of an event of interest can be contingent on meeting a particular pre-condition or post-condition; that is, a condition that must be met before the neural network detects an event of interest, and a condition that is met after.

One of the primary advantages of this pre-condition and post-condition checking is its ability to reduce “false-positive” recognitions. For example, an implementation of the NSHS could be configured to analyze accelerometer data to recognize when a user has lifted a smartphone to the ear, which in turn would automatically initiate a call to the most recent missed call. However, lifting the phone out of a bag or backpack and then setting it down face-up on a table should NOT initiate the call. In this case, a “lift” is encountered in both situations, but the second situation would be considered a “false positive.” Here, a post-condition check of the proximity sensor would allow the NSHS to clearly distinguish between the two scenarios described. In the first case, the proximity sensor will confirm an object is nearby (i.e. the user's face), while the second case will be “filtered out” and correctly ignored.

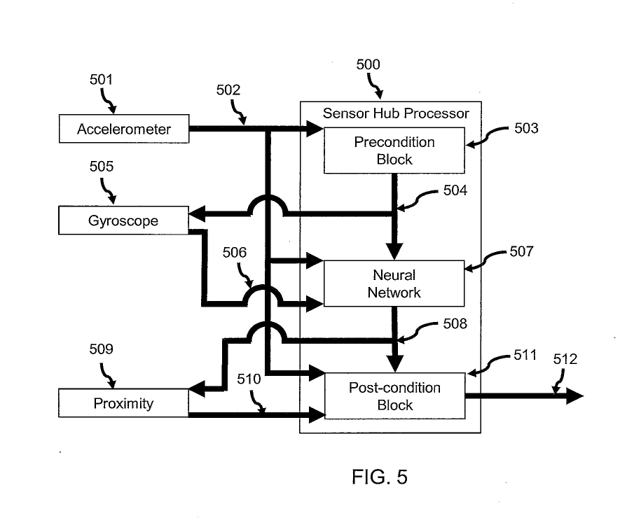

FIG. 5 illustrates an embodiment of a neural sensor hub system capable of pre-condition and post-condition checking according to another aspect of the present invention. In FIG. 5, it is considered that the embodiment performs a gesture-recognition task; more specifically, the NSHS detects when the device is lifted to the user's ear. Referring to FIG. 5, the software resides on a neural processing unit that includes Sensor Hub Processor (500) and memory (not shown). Initially, only one sensor is being sampled, the accelerometer (501). Limiting the number of sensors being sampled for the pre-condition event, as well as the sampling rate, provides an opportunity for additional power savings in the NSHS. The accelerometer data is propagated to Sensor Hub Processor 500 via an I2C bus (502). On Sensor Hub Processor 500, the Pre-condition Block (503) is configured to check whether the devices is still (e.g. resting on a table) or is moving (e.g. potentially being lifted to the ear).

In the described embodiment, a simple threshold function of the accelerometer data is used; however, more complex schemes, including neural networks, can be used for Pre-condition Block 503. Once Pre-condition Block 503's “condition” has been met, a “wakeup” signal (504) may turn on additional sensors, such as the gyroscope (505), as well as the event-of-interest-detecting neural network (507). In this described embodiment, any significant motion on the accelerometer is detected by Pre-condition Block 503, which enables Neural Network 507 to look for its event of interest—in this case, the motion of lifting the device to the ear. Neural Network 507 receives accelerometer data as well as gyroscope data via the I2C bus (402,406).

Once the event of interest is detected (e.g. the lift was detected), the neural network sends a “wakeup” signal (508) to the proximity sensor (509), as well as a Post-condition Block (511). Post-condition Block 511 receives proximity data via an I2C bus (510), as well as accelerometer data via I2C Bus 502. It should be noted that typically all the sensors are on a single I2C bus, though this is not always the case. In the described embodiment, Post-condition Block 511 looks for two conditions: that Proximity Sensor 509 indicates an object is near (i.e. the user's head) and Accelerometer 501 indicates the device is being held at an appropriate angle (i.e. the normal holding position when using a phone). If these conditions are met, an output (512) may be communicated or initiate some action.

In summary, the described embodiment initially uses the accelerometer only to detect when the device is being moved. Once the device is in motion, the gyroscope is activated to provide additional sensory information which is used by the neural network. The neural network then recognizes the event of interest (i.e. lifting the phone to the ear), after which the proximity sensor is activated. The proximity sensor and accelerometer are then checked to confirm the phone is in the “holding” position, and the output is generated.

It should be noted that FIG. 5 and the accompanying description are just one example embodiment of this “Sequence Recognition” capability of the NSHS. The Pre-condition and Post-condition Blocks may be composed of neural network instantiations, variations of neural networks, simple thresholding schemes such as those described above, or other non-neural-network algorithm techniques. Variations of the Sequence Recognition capability may utilize multiple Pre-condition or Post-condition Blocks, or may use just Pre-condition Blocks, or just Post-condition Blocks. Furthermore, intermediate outputs from the Pre-condition Blocks or the neural network may be utilized for other purposes. For example, the output of the Pre-condition Block in FIG. 4 may be used to turn the devices screen on momentarily (e.g. a small movement turns the screen on to display the current time).

As discussed above, an NSHS according to the present invention has various advantages over the existing sensor hub systems. First, an NSHS is capable of supporting multiple instantiations. Second, the NSHS can leverage many computational and resource management optimizations. Third, NSHS is capable of conditional and sequence recognition through pre-condition and post-condition checking.

Although the present invention has been particularly described with reference to the preferred embodiments thereof, it should be readily apparent to those of ordinary skill in the art that changes and modifications in the form and details may be made without departing from the spirit and scope of the invention. It is intended that the appended claims encompass such changes and modifications.

What is claimed is:

1. A scalable sensor hub system for detecting sensory events of interest, comprising:
a neural processing unit, wherein the neural processing unit comprises one or more dedicated low-power processors and memory storing one or more neural networks for execution by the one or more processors; and
one or more sensors, wherein output of the one or more sensors are converted into a spike signal, and the neural processing unit takes the spike signal as input and determines whether a sensory event of interest has occurred.

2. The system of claim 1, wherein the one or more neural networks are Recurrent Spiking Neural Networks (RSNN).

3. The system of claim 2, wherein the RSNN comprises a Liquid State Machine (LSM).

4. The system of claim 1, wherein the one or more neural networks uses spiking Linear Integrated-and-Fire neurons.

5. The system of claim 4, further comprising an input converter that converts output of the one or more sensors into a spike signal input to the neural processing unit.

6. The system of claim 4, further comprising an output classifier that classifies the activity states of the neural processing unit.

7. The system of claim 6, wherein the output classifier is a linear threshold classifier.

8. The system of claim 4, wherein the event of interest occurred as a result of occurrence of a plurality of conditions and at least one of the plurality of conditions is detected by the neural processing unit.

9. The system of claim 8, wherein the plurality of conditions are detected in a prescribed time order.

10. The system of claim 9, wherein at least one of the one or more sensors is activated in response to detection of one of the plurality of conditions by the neural processing unit.

11. The system of claim 1, wherein at least one of the one or more sensors is always activated.

12. A method, performed by a scalable sensor hub system having one or more sensors, one neural processing unit comprising one or more dedicated low power processors and a memory storing one or more neural networks for execution by the one or more processors, the method comprising:
converting output of the one or more sensors into a spike signal in response to an input signal to the one or more sensors;
receiving the spike signal at the one or more dedicated low power processors; and
determining by the neural processing unit whether a sensory event of interest has occurred.

13. The method of claim 12, wherein the determining comprises classifying the states of the neural processing unit.

14. The method of claim 13, wherein the classifying comprises performing linear threshold classification.

15. The method of claim 12, wherein the determining comprises detecting all of a plurality of conditions that together causes the event of interest to take place, and at least one of the plurality of conditions being detected by the neural network.

16. The method of claim 15, wherein the plurality of conditions are detected in a prescribed time order.

17. The method of claim 15, further comprising activating at least one of the one or more sensors in response to detecting one of the plurality of conditions.

18. A method, performed by a scalable sensor hub system having one or more sensors, one neural processing unit comprising one or more dedicated low power processors and a memory storing one or more neural networks using spiking Linear Integrated-and-Fire neurons for execution by the one or more processors, the method comprising:
converting output of the one or more sensors into spike signal in response to an input signal to the one or more sensors;
receiving the spike signal at the one or more dedicated low power processors; and
determining by the neural processing unit whether a sensory event of interest has occurred.

19. The method of claim 18, wherein the determining comprises detecting all of a plurality of conditions that together causes the event of interest to take place, and at least one of the plurality of conditions being detected by the neural network.

20. The method of claim 18, wherein the plurality of conditions are detected in a prescribed time order.

21. The method of claim 18, further comprising activating at least one of the one or more sensors in response to detecting one of the plurality of conditions.
